(19) United States
(12) Patent Application Publication
(10) Pub. No.: US 2025/0272556 A1
(43) Pub. Date: Aug. 28, 2025

(54) DATA PROCESSING METHOD AND APPARATUS, AND ELECTRONIC DEVICE

(71) Applicant: TENCENT TECHNOLOGY (SHENZHEN) COMPANY LIMITED, Shenzhen (CN)

(72) Inventor: Bingzhe WU, Shenzhen (CN)

(21) Appl. No.: 19/191,888

(22) Filed: Apr. 28, 2025

Related U.S. Application Data
(63) Continuation of application No. PCT/CN2024/084331, filed on Mar. 28, 2024.

(30) Foreign Application Priority Data
Mar. 30, 2023 (CN) 202310378785.5

(51) Int. Cl. G06N 3/08; G06F 18/24; G06F 18/25; G06N 3/0475

(52) U.S. Cl. CPC G06N 3/08; G06F 18/24; G06F 18/253; G06N 3/0475

(57) ABSTRACT

A data processing method and apparatus, and an electronic device are provided. The method includes inputting the multi-modal data into a large natural language model, and performing the following operations based on the large natural language model: performing feature extraction to obtain an element feature and a position feature, characterizing a character position of each element in the multi-modal data; fusing the element feature and the position feature to obtain a fused feature; obtaining a multi-modal data category and a confidence score corresponding to the multi-modal data category based on the fused feature. The large natural language model is trained by inputting auxiliary training information during training of the large natural language model, so that the large natural language model is configured to obtain the confidence score after the training is completed, and presenting corresponding feedback information based on the multi-modal data category and the confidence score.

### RELATED APPLICATIONS

This application is a continuation of PCT Application No. PCT/CN2024/084331, filed on Mar. 28, 2024, which claims priority to Chinese Patent Application No. 202310378785.5, filed with the China National Intellectual Property Administration on Mar. 30, 2023, and entitled “DATA PROCESSING METHOD AND APPARATUS, AND ELECTRONIC DEVICE”, which are both incorporated herein by reference in their entirety.

### FIELD OF THE TECHNOLOGY

This application relates to the field of computer technologies, and in particular, to a data processing method and apparatus, and an electronic device.

### BACKGROUND OF THE DISCLOSURE

In recent years, with the growth of high-quality data accumulated in industry, the growth of computing power resources, and the development of large-scale model architectures and training technologies, the large language model (for example, GPT-3) and the like are widely applied to use scenarios such as translations, dialogs, and advertisement recommendations. Compared with a conventional “small model”, a large language model has large model parameter quantity, calculation quantity, and storage capacity, and therefore has a stronger expression capability and data fitting capability. This greatly improves performance of a neural network model in various services, and exceeds performance of human experts in many tasks. However, since a large quantity of computing and storage resources need to be occupied in the training process of a large language model, it is very expensive for most individuals or enterprises to run such a model. Therefore, an existing large language model usually provides a corresponding service for a user through a cloud computing application programming interface (API).

In the related art, the large language model can usually classify data inputted by the user, and provide a data classification result for the user through a cloud computing API, to provide the service for the user.

However, often, the large language model can only transmit a determined data category to the user, resulting in relatively simple data available to a downstream task of the user, thereby reducing reliability of decision-making of the downstream task based on the data category.

### SUMMARY

An objective of this application is to provide a data processing method and apparatus, and an electronic device, to provide a more reliable data processing method, thereby increasing a degree of accuracy of feeding back information to a target object.

One aspect of this application provides a data processing method, the method including receiving multi-modal data, and inputting the multi-modal data into a large natural language model; performing the following operations based on the large natural language model: performing feature extraction on the multi-modal data to obtain an element feature and a position feature of the multi-modal data, the element feature characterizing element information of each element in the multi-modal data, and the position feature characterizing a character position of each element in the multi-modal data; fusing the element feature and the position feature corresponding to the multi-modal data to obtain a fused feature; obtaining a multi-modal data category of the multi-modal data and a confidence score corresponding to the multi-modal data category based on the fused feature, the confidence score characterizing a degree of accuracy of a corresponding classification result, and the large natural language model being trained by inputting auxiliary training information during training of the large natural language model, so that the large natural language model is configured to obtain the confidence score corresponding to the multi-modal data after the training is completed, the auxiliary training information characterizing a degree of accuracy of a sample category corresponding to a training sample for training the large natural language model; and presenting corresponding feedback information based on the multi-modal data category and the confidence score.

Another aspect of this application provides a data processing apparatus, including: an obtaining module, configured to obtain multi-modal data inputted by a target object, and input the multi-modal data into a large natural language model; an extraction module, configured to perform the following operations based on the large natural language model: performing feature extraction on the multi-modal data to obtain an element feature and a position feature of the multi-modal data, the element feature being configured for characterizing element information of each element in the multi-modal data, and the position feature being configured for characterizing a character position of each element in the multi-modal data; fusing the element feature and the position feature corresponding to the multi-modal data to obtain a fused feature; obtaining a multi-modal data category of the multi-modal data and a confidence score corresponding to the multi-modal data category based on the fused feature, the confidence score being configured for characterizing a degree of accuracy of a corresponding classification result, and the large natural language model being trained by inputting auxiliary training information during training of the large natural language model, so that the large natural language model obtains the confidence score corresponding to the multi-modal data after the training is completed, the auxiliary training information being configured for characterizing a degree of accuracy of a sample category corresponding to a training sample for training the large natural language model; and a presentation module, configured to present corresponding feedback information to the target object based on the multi-modal data category and the confidence score.

Another aspect of this application provides an electronic device, including a processor and a memory, the memory having a program code stored therein, the program code, when executed by the processor, causing the processor to perform the method according to any one of the embodiments of this application.

Another aspect of this application provides a non-transitory computer storage medium, the computer storage medium having a computer instruction stored therein, the computer instruction, when run on a computer, causing the computer to perform the method according to any one of embodiments of this application.

The foregoing technical solutions used in the embodiments of this application have at least the following technical effects.

According to the embodiments of this application, the confidence score corresponding to the multi-modal data category can be determined through a trained large natural language model, the accuracy of the corresponding multi-modal data category can be represented through the confidence score, and the determined confidence score is used as reference information of the downstream task, thereby improving accuracy and reliability of the downstream task.

Other features and advantages of this application are to be described subsequently in the specification, and partly become apparent from the specification, or may be learned through implementation of this application. Objectives and other advantages of this application may be implemented and obtained through solutions particularly pointed out in the written specification, claims, and accompanying drawings.

### BRIEF DESCRIPTION OF THE DRAWINGS

To describe the technical solutions of embodiments of this application more clearly, the accompanying drawings required for use in the embodiments of this application are briefly described below. Apparently, the accompanying drawings described below show only some embodiments of this application, and a person of ordinary skill in the art may still derive other accompanying drawings from these accompanying drawings without creative efforts.

FIG. 1 is an application scenario of a data processing method according to an embodiment of this application.

FIG. 2 is a flowchart of a data processing method according to an embodiment of this application.

FIG. 3 is a schematic diagram of each element feature corresponding to multi-modal data according to an embodiment of this application.

FIG. 4 is a schematic diagram of a large natural language model according to an embodiment of this application.

FIG. 5A is a schematic diagram of a presented interface according to an embodiment of this application.

FIG. 5B is a schematic diagram of a presented interface according to an embodiment of this application.

FIG. 6A is a schematic diagram of a presented interface according to an embodiment of this application.

FIG. 6B is a schematic diagram of a presented interface according to an embodiment of this application.

FIG. 7 is a flowchart of training a large natural language model according to an embodiment of this application.

FIG. 8 is a flowchart of obtaining a training sample set according to an embodiment of this application.

FIG. 9 is a schematic diagram of clustering according to an embodiment of this application.

FIG. 10 is a schematic diagram of clustering according to an embodiment of this application.

FIG. 11 is a flowchart of a iterative training process according to an embodiment of this application.

FIG. 12 is a schematic logic diagram of application to a chatbot according to an embodiment of this application.

FIG. 13 is a schematic logic diagram of application to a resume evaluation system according to an embodiment of this application.

FIG. 14 is a schematic diagram of a data processing apparatus according to an embodiment of this application.

FIG. 15 is a schematic diagram of an electronic device according to an embodiment of this application.

FIG. 16 is a schematic diagram of an electronic device according to an embodiment of this application.

### DESCRIPTION OF EMBODIMENTS

To make the objectives, technical solutions, and advantages of this application clearer, this application is to be further described in detail below with reference to the accompanying drawings. Apparently, the described embodiments are merely some rather than all of the embodiments of this application. All other embodiments obtained by a person of ordinary skill in the art based on the embodiments of this application without creative efforts fall within the protection scope of this application.

To help a person skilled in the art understand the technical solutions of this application better, some terms involved in this application are described below.

K-means clustering algorithm-It is an iterative clustering analysis algorithm, including dividing data into K groups in advance, randomly selecting K objects as an initial cluster center, then calculating a distance between each object and each seed cluster center, and assigning each object to the cluster center closest to the object. The cluster center and the object assigned to the cluster center represent a cluster. Each time a sample is assigned, a cluster center of the cluster is recalculated based on an existing object in the cluster. This process is continuously repeated until a termination condition is satisfied. The termination condition may be that no (or only a minimum quantity of) objects are reassigned to different clusters, no (or only a minimum quantity of) cluster centers change again, and a sum of squared errors is locally minimized.

The word “exemplary” used below means “serving as an example, an embodiment, or an illustration”. Any embodiment described as “exemplary” is not necessarily to be construed as being superior to or better than another embodiment.

The terms “first” and “second” herein are merely used for description, and cannot be construed as explicitly or implicitly indicating relative importance or implicitly indicating a quantity of indicated technical features. Therefore, a feature defined to be “first” or “second” may explicitly or implicitly include one or more features. In the description of embodiments of this application, unless otherwise stated, “a plurality of” refers to two or more.

The embodiments of this application relate to an artificial intelligence (AI) technology, and are designed based on machine learning (ML) and a speech technology in AI.

AI is a theory, a method, a technology, and an application system that uses a computer or a machine controlled by the computer to simulate, extend, and expand human intelligence, perceive the environment, acquire knowledge, and obtain the best result with knowledge. In other words, AI is a comprehensive technology in computer science and attempts to understand the essence of intelligence and produce a new intelligent machine that can respond in a manner similar to human intelligence. AI technology studies the design principles and implementation methods of various intelligent machines, to enable the machines to have the functions of perception, reasoning, and decision-making.

The AI technology is a comprehensive discipline, and involves a wide range of fields including both the hardware-level technology and the software-level technology. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing (NLP) technology, and machine learning/deep learning.

NLP is an important direction in the fields of computer science and AI, which studies various theories and methods that can implement effective communication between humans and computers through natural language. NLP is a science that integrates linguistics, computer science, and mathematics. Therefore, research in this field relates to natural languages, namely, languages daily used by people, and therefore is closely related to the study of linguistics. The NLP technologies usually include technologies such as text processing, semantic understanding, machine translation, robot question-answering, and knowledge graphs.

ML is an interdisciplinary field, which involves a plurality of disciplines such as the theory of probability, statistics, the approximation theory, convex analysis, and the theory of algorithm complexity. ML specializes in studying how a computer simulates or implements learning behaviors of humans to obtain new knowledge or skills, and reorganize an existing knowledge structure, to keep improving performance thereof. ML is the core of AI, is a basic way to make the computer intelligent, and is applied to various fields of AI. ML and the deep learning generally include technologies such as an artificial neural network, a confidence network, reinforcement learning, transfer learning, inductive learning, and learning from demonstration.

Key technologies of the speech technology include an automatic speech recognition (ASR) technology, a text-to-speech (TTS) technology, and a voiceprint recognition technology. The ability of a computer to listen, see, speak, and feel is the future development direction of human-computer interaction, and speech is becoming one of the most promising human-computer interaction manners in the future.

A design concept of embodiments of this application is briefly described below.

In the related art, texts inputted by a user are usually classified through a large language model (for example, GPT-3), and a classification result is transmitted to the user, so that the user decides based on the classification result. However, since only a determined text category can be transmitted to the user, this results in relatively simple data available to the user when making a decision. Therefore, when the user makes a decision based only on the text category, reliability of the decision made is reduced. In view of shortcomings of a method for classifying the texts through such a large language model, the embodiments of this application provide a data processing method and apparatus, and an electronic device. According to the embodiments of this application, after multi-modal data inputted by a target object (i.e., a user) is obtained, a multi-modal data category of the multi-modal data can be determined through a trained large natural language model. In addition, according to the embodiments of this application, a confidence score corresponding to the multi-modal data category can be further determined, accuracy of the corresponding multi-modal data category can be represented through the confidence score, and the determined confidence score is used as reference information of a downstream task, thereby improving accuracy and reliability of the downstream task. For example, after obtaining the multi-modal data category corresponding to the multi-modal data and the confidence score, a chatbot may determine a multi-modal data category with higher accuracy based on the confidence score, and further determine more accurate feedback information based on a more accurate multi-modal data category, thereby improving accuracy of feedback to the target object, and improving reliability of automatic crosstell of the chatbot.

The embodiments of this application are described below with reference to the accompanying drawings. The embodiments described herein are merely used for illustrating and explaining this application and are not intended to limit this application, and the embodiments of this application and features in the embodiments may be combined with each other in case of no conflict.

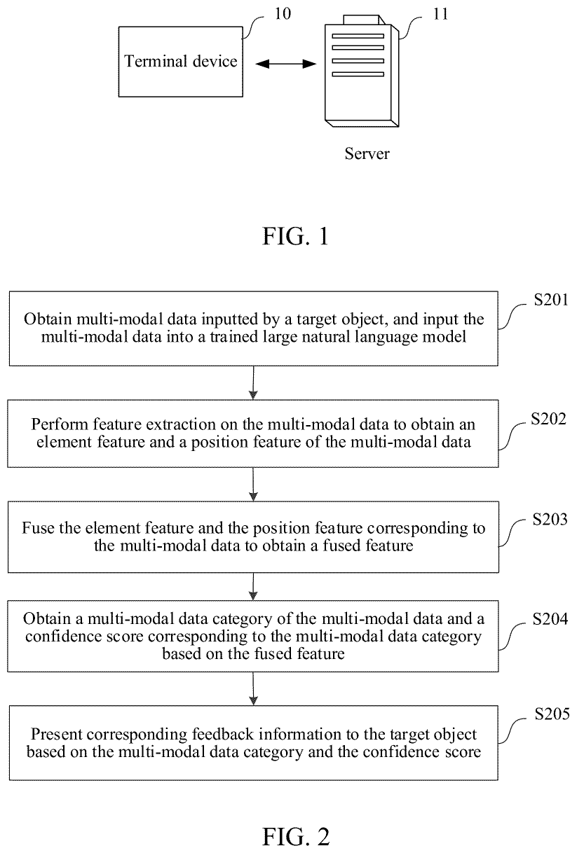

FIG. 1 is a schematic diagram of an application scenario of a data processing method according to an embodiment of this application. The schematic diagram of the application scenario includes a terminal device 10 and a server 11. The terminal device 10 and the server 11 may communicate with each other through a communication network. In some embodiments, the communication network may be a wired network or a wireless network. Therefore, the terminal device 10 and the server 11 may be directly or indirectly connected through wired or wireless communication, which is not specifically limited in the embodiments of this application.

In the embodiments of this application, the terminal device 10 is an electronic device used by a target object. The electronic device may be a computer device having a specific computing capability and having instant messaging software and websites or social software and websites run therein, such as a personal computer, a mobile phone, a tablet computer, a notebook computer, an e-book reader, an intelligent voice interaction device, a smart home device, or an on-board terminal. The server 11 may be an independent physical server, or may be a server cluster formed by a plurality of physical servers or a distributed system, and may further be a cloud server providing basic cloud computing services such as cloud service, a cloud database, cloud computing, cloud storage, a cloud function, a network service, cloud communication, a middleware service, a domain name service, a security service, a content delivery network (CDN), and a big data and artificial intelligence platform.

In the embodiments of this application, the large natural language model may be deployed on the terminal device 10 for training, or may be deployed on the server 11 for training. In some embodiments, when the large natural language model is deployed on the server 11 for training, the server 11 may have a large number of training sample sets stored therein. Each of the training sample sets includes a plurality of training samples and a sample category and auxiliary training information corresponding to each training sample, which are configured for training the large natural language model.

After the trained large natural language model is obtained based on the training method in the embodiments of this application, the trained large natural language model may be directly deployed on the terminal device 10 or the server 11, and the data processing method in the embodiments of this application is performed through the terminal device 10 or the server 11 alone. Alternatively, the terminal device 10 and the server 11 may also cooperate with each other to perform the data processing method in the embodiments of this application. During implementation, the trained large natural language model may be deployed on the server 11. The terminal device 10 receives to-be-processed multi-modal data, and transmits the multi-modal data to the server 11. The server 11 performs a data processing method on the multi-modal data, and then provides feedback to the target object through the terminal device 10.

For example, after the server 11 receives the multi-modal data transmitted by the terminal device 10, the server 11 determines the multi-modal data category corresponding to the multi-modal data and the confidence score corresponding to the multi-modal data category, determines corresponding feedback information based on the multi-modal data category corresponding to the multi-modal data and the confidence score corresponding to the multi-modal data category, transmits the feedback information to the terminal device 10, and then presents the corresponding feedback information to the target object through the terminal device 10.

Alternatively, after the server 11 receives the multi-modal data transmitted by the terminal device 10, the server 11 determines the multi-modal data category corresponding to the multi-modal data and the confidence score corresponding to the multi-modal data category, and transmits the multi-modal data category corresponding to the multi-modal data and the confidence score corresponding to the multi-modal data category to the terminal device 10. The terminal device 10 determines corresponding feedback information based on the multi-modal data category corresponding to the multi-modal data and the confidence score corresponding to the multi-modal data category, and presents the corresponding feedback information to the target object.

The data processing method provided in the embodiments of this application may be applied to various application scenarios including a data processing task, for example, a multi-modal data processing module of some robot question-answering platforms, a session processing module of a session auditing platform corresponding to some chat software, and a comment processing module of some content sharing platforms, and may further be configured for performing data processing on private conversations, public information, public conversations, and the like of some target objects. These modules may be deployed on a corresponding platform, or may be deployed on a cloud server. The platform may serve as a tenant to purchase a corresponding cloud resource on the cloud server, to implement data processing functions of the modules. If no module is deployed on the cloud server, the cloud server may provide an API for a platform, so that the platform may transmit data that needs to be processed to the cloud server through the API, and the cloud server returns a result of performing data processing on the multi-modal data to the platform through the API.

An example in which the data processing method in the embodiments of this application is applied to a multi-modal data processing module of a robot question-answering platform is used. Multi-modal data inputted by a target object is obtained, a trained large natural language model is configured on the multi-modal data processing module, and a multi-modal data category corresponding to the multi-modal data and a confidence score corresponding to the multi-modal data category are determined through the multi-modal data processing module. The corresponding feedback information is determined based on the multi-modal data category corresponding to the multi-modal data and the confidence score corresponding to the multi-modal data category, and the feedback information is presented to the target object through the robot question-answering platform.

In addition to the data processing method in the embodiments of this application being applied to the multi-modal data processing module of the foregoing robot question-answering platform, to process real-time session multi-modal data, the data processing method may also be applied to another business scenario, for example, a data processing task such as text data processing, short message processing, news title processing, picture processing, video processing, or speech processing in a client.

In the embodiments of this application, the multi-modal data category corresponding to the multi-modal data and the confidence score corresponding to the multi-modal data category may be further determined through the data processing method. The downstream task may determine feedback information based on the multi-modal data category corresponding to the multi-modal data and the confidence score corresponding to the multi-modal data category, and present the corresponding feedback information to the object.

The data processing method provided in the embodiments of this application is described below with reference to the accompanying drawings based on the application scenarios described in the foregoing embodiments. The foregoing application scenarios are merely shown to facilitate understanding of the spirit and principle of this application, and the embodiments of this application are not limited in this regard.

FIG. 2 is a flowchart of a data processing method according to an embodiment of this application. The method may be performed by an electronic device. The electronic device may be the terminal device in FIG. 1, or may be the server in FIG. 1. A specific implementation process of the method includes the following operations S201-S205.

Operation S201: Obtain multi-modal data inputted by a target object, and input the multi-modal data into a large natural language model. In one embodiment, the large natural language model may be a trained large natural language model.

The multi-modal data refers to data obtained from different fields or perspectives for the same descriptive object, and each field or perspective for describing the data is referred to as a modality. A different existence form or information source may be referred to as a modality. Data formed by two or more modalities is referred to as multi-modal data. Multi-modality is configured for representing a data form of different types or different formats of a same type.

In one embodiment, the multi-modal data may include, but is not limited to, text data, a picture, an audio, a video, or a combination of at least two of the text data, the picture, the audio, and the video.

For example, the multi-modal data may be text data, voice, a picture, a video clip, or a file inputted by the target object. A manner of obtaining the multi-modal data is not limited in the embodiments of this application.

The text data inputted by the target object may be a piece of text data inputted by the target object through an input method keyboard, or a piece of text data intercepted from all text data inputted by the target object. In addition, a language category of the obtained text data is not limited by the embodiments this application. For example, the language category of the text data may be Chinese or English.

The following operations S202-S204 are performed based on the trained large natural language model.

Operation S202: Perform feature extraction on the multi-modal data to obtain an element feature and a position feature of the multi-modal data.

The trained large natural language model includes an input layer, an embedding layer, and at least one encoding layer.

The large natural language model in the embodiments of this application is a deep learning model for NLP and another sequence-to-sequence learning task, which may be for example a GPT model. The GPT model includes but is not limited to a GPT-1 model, a GPT-2 model, a GPT-3 model, a GPT-4 model, and a ChatGPT model.

During implementation, feature extraction is performed on the multi-modal data based on the input layer of the trained large natural language model, to obtain element features (token features) and position features that correspond to the multi-modal data.

Each of the element features is configured for characterizing element information of each element in the multi-modal data. The element information may include semantic information or another attribute of an element. Therefore, the element feature refers to a feature extracted from each element (word or character) to represent semantic information or another attribute of each element. During the NLP, the element feature is usually extracted by converting each element into an embedding vector. The embedding vector is a high-dimensional representation of an element, which can capture a semantic relationship between elements.

An example in which the multi-modal data is a text sentence “Xiao Ming went for a spring outing today” is used. If this sentence is divided into a single character (a Chinese character in Chinese is used as a character, the same as a word in English) as an element, each of the characters “Xiao”, “Ming”, “went for”, “a”, “spring”, “outing”, and “today” is converted into an embedding vector. These embedding vectors are used as element features and are inputted into a trained large natural language model for further processing.

The position feature is configured for characterizing relative or absolute position information of each element in the multi-modal data, and the position feature may help a large natural language model understand a positional relationship of each element in a sentence. The relative or absolute position information may be represented through a character position. The “character position” herein refers to a position of an element in the entire multi-modal data.

When the multi-modal data is text data, the element may be a Chinese character, or may be a participle, an English word, or the like in the multi-modal data, or a plurality of words are used as an element, which is not specifically limited in this application. When an element is formed by a plurality of words or a plurality of participles, the “character position” herein refers to a position of the first word or Chinese character (i.e., a character) in the element in the entire multi-modal data, namely, (when the multi-modal data is an input sequence) a start position of the element in the entire input sequence (sometimes also including a start position and an end position of the element in the entire input sequence).

A finally extracted position feature may be a mathematical representation based on these character positions, such as a one-dimensional position index vector, or a more complex encoding form (for example, implemented through position encoding or position embedding), which is not limited in the embodiments of this application.

For example, when the multi-modal data is “Xiao Ming went for a spring outing today”, “a spring outing” may be considered as an element. Assuming that a character index is used as a character position (counting starts from 0) for representing position information of an element, a character position of “spring” is 6, and a character position of “outing” is 7, a position feature of “spring outing” may be represented by the start position 6 thereof (or a certain combination form of 6 and 7), which is not limited in the embodiments of this application.

In this embodiment, the position feature may enable the trained large natural language model to learn a positional relationship of each element in a sentence, and semantic information of the element is provided based on the element feature. The combination of the position feature and the element feature may cause the trained large natural language model to better understand and process natural language data.

In some embodiments, based on the input layer of the trained large natural language model, the element feature corresponding to each element may be determined based on element information of each element in the foregoing multi-modal data, and the position feature corresponding to each element may be determined based on the character position of each element in the multi-modal data.

In some embodiments, in the foregoing operation S202, the performing feature extraction on the multi-modal data to obtain an element feature and a position feature of the multi-modal data specifically includes the following operations A1-A3.

A1: Receive multi-modal data inputted by a target object, and divide the multi-modal data into elements.

In some embodiments, if multi-modal data is text data, for example, “Xiao Ming went for a spring outing today”, elements of the multi-modal data may be: Xiao Ming, went for, a spring outing, and today.

A2: Obtain an element feature of each element based on element information of each element, to obtain an element feature of the multi-modal data.

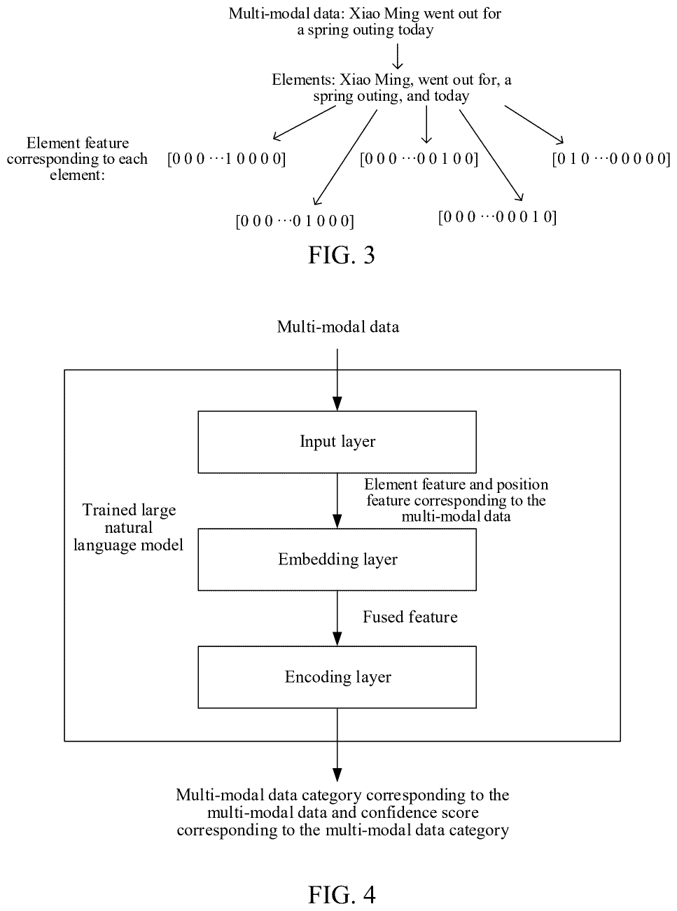

FIG. 3 is a schematic diagram of each element feature corresponding to a multi-modal data according to an embodiment of this application. If the multi-modal data is text data, based on the multi-modal data of “Xiao Ming went for a spring outing today” in the figure, elements are determined as Xiao Ming, went for, a spring outing, and today. The element feature corresponding to each element in the multi-modal data is determined based on an input layer in a trained large natural language model. A method for determining the element feature of each element in the multi-modal data is described above, and details are not described herein again.

A3: Obtain a corresponding position feature based on a character position of each element in the multi-modal data.

In some embodiments, in the input layer of the trained large natural language model, the corresponding position feature is obtained based on the character position of each element in the multi-modal data.

Operation S203: Fuse the element feature and the position feature corresponding to the multi-modal data to obtain a fused feature.

In some embodiments, based on an embedding layer of the trained large natural language model, the element feature and the position feature corresponding to the multi-modal data are fused to obtain a fused feature.

In some embodiments, the fusing the element feature and the position feature corresponding to the multi-modal data to obtain a fused feature includes the following operations:

A: Generate a corresponding position code (positional encoding) for each element in the multi-modal data.

In some embodiments of this application, for the position feature of each element, a position code having the same dimension as the element feature (embedding vector) is generated. Therefore, the position code is a vector. The position code may be generated through a predefined mathematical function. For example, a combination of sine and cosine functions is used to generate a position code based on the position feature of each element, to ensure that each position has a unique position code.

B: Fuse the element feature of each element and the corresponding position code, to obtain a fused feature.

In some embodiments of this application, the embedding vector representing the element feature of each element and the corresponding position code are added or combined in another manner (for example, through nonlinear transformation after splicing), to generate a fused feature. It is a common fusion strategy to fuse the two through addition, because independence between an element feature and a position feature can be maintained through the strategy, so that the trained large natural language model also considers position information of each element when processing the element.

Therefore, the fused feature includes semantic information of the element and relative position information of the element in a sequence. Such a fused feature enables the model to not only understand the meaning of each element (such as a word or a character), but also understand a role and a relationship of the element in an entire sentence or sequence.

For example, when the multi-modal data is the sentence “Xiao Ming went for a spring outing today”, elements including “Xiao Ming”, “went for”, “a spring outing”, and “today” are first converted. Each of the elements is converted into an embedding vector (assuming that the embedding vector has 100 dimensions), and position codes of these elements having the same dimension (100 dimensions) are generated based on position features of these elements (assuming that a start position of “Xiao Ming” is 0, a start position of “today” is 2, and so on). Then for each element, the embedding vector of the element and the corresponding position code are added to obtain a result that is a fused feature. For example, if an embedding vector of “Xiao Ming” is a 100-dimensional vector\[0.25, −0.4, . . . \], a position code thereof may be \[0.3, 0.1, . . . \], and a fused feature obtained through fusion after the addition is \[0.55, −0.3, . . . ]. The fused feature obtained in this way includes both semantic information of the element “Xiao Ming” and position information of the element “Xiao Ming” in the sentence, so that the trained large natural language model can consider that the element “Xiao Ming” is not only a name, but also the first element in the sentence during the processing.

Operation S204: Obtain a multi-modal data category of the multi-modal data and a confidence score corresponding to the multi-modal data category based on the fused feature.

The confidence score is configured for characterizing a degree of accuracy of a corresponding classification result.

The large natural language model is trained by inputting auxiliary training information during training of the large natural language model, so that the large natural language model obtains the confidence score corresponding to the multi-modal data after the training is completed, the auxiliary training information being configured for characterizing a degree of accuracy of a sample category corresponding to a training sample for training the large natural language model.

In some embodiments, the following operations are performed in at least one encoding layer of the trained large natural language model.

A: Determine the multi-modal data category corresponding to the multi-modal data and the confidence score corresponding to the multi-modal data category based on the fused feature and a weight matrix corresponding to each encoding layer.

The weight matrix corresponding to each encoding layer is determined during the training of the trained large natural language model. The weight matrix converts the multi-modal data in each encoding layer of the trained large natural language model, to capture different features of the multi-modal data, thereby helping the trained large natural language model to learn a mapping relationship between the inputted multi-modal data and an outputted category. The encoding layers of the foregoing trained large natural language model may include a convolutional layer, a circulation layer, a transformer layer, and the like. These encoding layers may process the fused features, and capture and learn deep patterns and relationships of the inputted multi-modal data.

In the embodiments of this application, if a plurality of encoding layers exist in the trained large natural language model, each of the fused features is inputted into each encoding layer in the trained large natural language model. For any encoding layer in the trained large natural language model, a corresponding fusion result is determined based on the fused feature and the weight matrix corresponding to each encoding layer. When a fusion result is determined, on each encoding layer, a matrix multiplication operation is performed on the fused feature and a weight matrix of the layer, a bias term (if any) is added to the product, and then the obtained result is inputted into a nonlinear activation function. The foregoing process is referred to as forward propagation.

B: Connect the fusion results obtained on a plurality of encoding layers in series, and determine a multi-modal data category corresponding to the multi-modal data and a confidence score corresponding to the multi-modal data category based on the fusion result after series connection.

In the embodiments of this application, the merged result obtained at the plurality of encoding layers is inputted into a classification layer, for example, a fully connected layer, to convert the fusion result into a vector corresponding to a category predicted by a model. Then the vector is inputted into an activation function (such as Softmax) for processing, and is converted into a probability distribution. Each value in the probability distribution represents a confidence score of the trained large natural language model for each category. The category corresponding to the largest probability value is the predicted multi-modal data category, and the largest probability value is the confidence score corresponding to the predicted multi-modal data category.

FIG. 4 is a schematic diagram of a large natural language model according to an embodiment of this application. In FIG. 4, obtained multi-modal data is inputted to an input layer of a trained large natural language model, and feature extraction is performed on the multi-modal data on the input layer, to obtain an element feature and a position feature corresponding to the multi-modal data. Based on an embedding layer in the trained large natural language model, the element feature and the position feature corresponding to the multi-modal data are fused to obtain a fused feature. Based on at least one encoding layer of the trained large natural language model, a multi-modal data category corresponding to the multi-modal data and a confidence score corresponding to the multi-modal data category are determined based on the fused feature and a weight matrix corresponding to each encoding layer that is determined during the training of the trained large natural language model. The multi-modal data category corresponding to the multi-modal data and the confidence score corresponding to the multi-modal data category are used as outputs of the trained large natural language model.

In some embodiments, if the data processing method is applied to a multi-modal data processing module in a robot question-answering platform, and the multi-modal data processing module may be deployed in a cloud server, the multi-modal data processing module may determine the multi-modal data category of the multi-modal data and the confidence score corresponding to the multi-modal data category based on received text data, voice, a picture, or the like inputted by a target object.

In some embodiments, the multi-modal data inputted by the target object includes at least one of the following: text data including a modal element, text data including an emotional element, and text data including an adjective element, the multi-modal data category determined based on the multi-modal data may be a category of sentiment.

In some embodiments, if the multi-modal data is text data, the modal element may be a modal particle in the text data, the emotional element may be an emotional noun in the text data, and the adjective element may be an adjective in the text data. If the multi-modal data is “What a nice day today! What fun!”, it is determined, based on the modal particle “what”, the adjective “nice”, and the emotional noun “fun” in the multi-modal data, that the category of sentiment corresponding to the multi-modal data may be a positive sentiment.

In some embodiments, the multi-modal data category may be a category of sentiment, a field category, a grade evaluation category, or the like. The field category may include a work field category, an academic field category, and the like. A type of the multi-modal data category is not limited in this application.

In some embodiments, a piece of multi-modal data may correspond to a plurality of multi-modal data categories. For example, a piece of multi-modal data may correspond to a field category, a grade evaluation category, or a work field category. A quantity of multi-modal data categories corresponding to the multi-modal data is not limited in this application.

In some embodiments, the category of sentiment may include a positive sentiment and a negative sentiment. The grade evaluation category may include a five-star review, a four-star review, a three-star review, a bad review, and the like. Similarly, the grade evaluation category may further include excellent, good, qualified, poor, and the like. Alternatively, the grade evaluation category may also include super recommendation, recommendation, average, no recommendation, and the like. The academic field category may include a single-chip microcomputer field, a neural network field, and the like.

Operation S205: Present corresponding feedback information to the target object based on the multi-modal data category and the confidence score.

In some embodiments, the presenting corresponding feedback information to the target object based on the multi-modal data category and the confidence score may include at least one of the following Method I and Method II:

Method I: Use the corresponding multi-modal data category as feedback information based on the confidence score, and present the feedback information to the target object.

In the embodiments of this application, the using the corresponding multi-modal data category as feedback information based on the confidence score may include the following Method 1 and Method 2, which are specifically described as follows:

Method 1: Rank corresponding multi-modal data categories based on magnitudes of numerical values of confidence scores, and use the ranked multi-modal data categories as feedback information.

Method 2: Screen the confidence scores based on a preset rule, and use a multi-modal data category corresponding to the selected confidence score as feedback information.

The embodiments of this application provide several scenarios where the corresponding multi-modal data category is used as feedback information based on the confidence score, which are specifically described as follows:

Scenario 1: After determining a multi-modal data category corresponding to the multi-modal data and a confidence score corresponding to the multi-modal data category, a cloud server uses the corresponding multi-modal data category as feedback information based on the confidence score, and transmits the feedback information to a corresponding client, and then the client presents the feedback information to a target object.

Scenario 2: After determining a multi-modal data category corresponding to the multi-modal data and a confidence score corresponding to the multi-modal data category, a cloud server transmits the multi-modal data category and the confidence score to a corresponding client, and the client uses the corresponding multi-modal data category as feedback information based on the confidence score, and presents the feedback information to a target object.

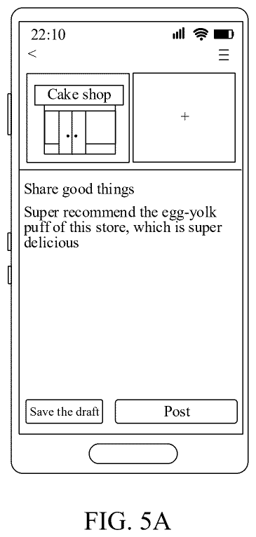

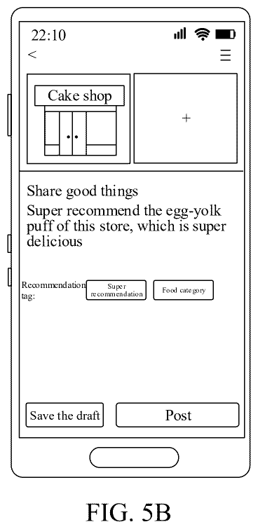

FIG. 5A is a schematic diagram of a presented interface according to an embodiment of this application. A display interface of a content sharing client installed on a terminal device is used as an example. A target object is currently using the content sharing client. Multi-modal data inputted by the target object is: super recommend the egg-yolk puff of this store, which is super delicious. The content sharing client on the terminal device transmits the multi-modal data to a cloud server, and the cloud server determines a multi-modal data category corresponding to the multi-modal data and a confidence score corresponding to each multi-modal data category through a trained large natural language model. Assuming that the multi-modal data categories determined by the cloud server are “super recommendation” and “food category”, a confidence score corresponding to the “super recommendation” is 100%, and a confidence score corresponding to the “food category” is 95%.

The cloud server ranks the “super recommendation” and the “food category” based on the confidence score of 100% corresponding to the “super recommendation” and the confidence score of 95% corresponding to the “food category”. Since the confidence score corresponding to the “super recommendation” is greater than the confidence score corresponding to the “food category”, the ranked “super recommendation” and “food category” are used as feedback information.

Alternatively, the cloud server transmits the determined multi-modal data category and the corresponding confidence score to the client. The client ranks the “super recommendation” and “food category” based on the confidence score of 100% corresponding to the “super recommendation” and the confidence score of 95% corresponding to the “food category”, and uses the ranked “super recommendation” and “food category” as feedback information.

As shown in FIG. 5B, the client ranks a tag of “super recommendation” prior to a tag of “food category” on a display interface based on the feedback information, to obtain a client display interface shown in FIG. 5B.

Method II: Determine reply content based on the multi-modal data category and the confidence score, use the reply content as feedback information, and present the feedback information to a target object.

The reply content may include at least one of the following: text data, a picture, voice, a video, and the like.

The embodiments of this application provide several scenarios where the reply content is determined based on a multi-modal data category and a confidence score, which are specifically described as follows:

Scenario 1: After determining a multi-modal data category corresponding to the multi-modal data and a confidence score corresponding to the multi-modal data category, a cloud server may determine reply content based on the multi-modal data category and the confidence score, and transmit the reply content as feedback information to a corresponding client, and then the client presents the feedback information to a target object.

The trained large natural language model in the embodiments of this application can also determine reply content corresponding to the multi-modal data based on the multi-modal data inputted by the target object.

Scenario 2: After determining a multi-modal data category corresponding to the multi-modal data and a confidence score corresponding to the multi-modal data category, a cloud server inputs the multi-modal data category and the confidence score into a downstream task, determines reply content in the downstream task based on the multi-modal data category and the confidence score, and presents the reply content as feedback information to a target object.

The multi-modal data category corresponding to the multi-modal data and the confidence score corresponding to the multi-modal data category are provided for the downstream task, to assist the downstream task in determining feedback information and present the feedback information to the target object, thereby resolving a problem that the downstream task cannot determine the multi-modal data category and the confidence score due to limited conditions.

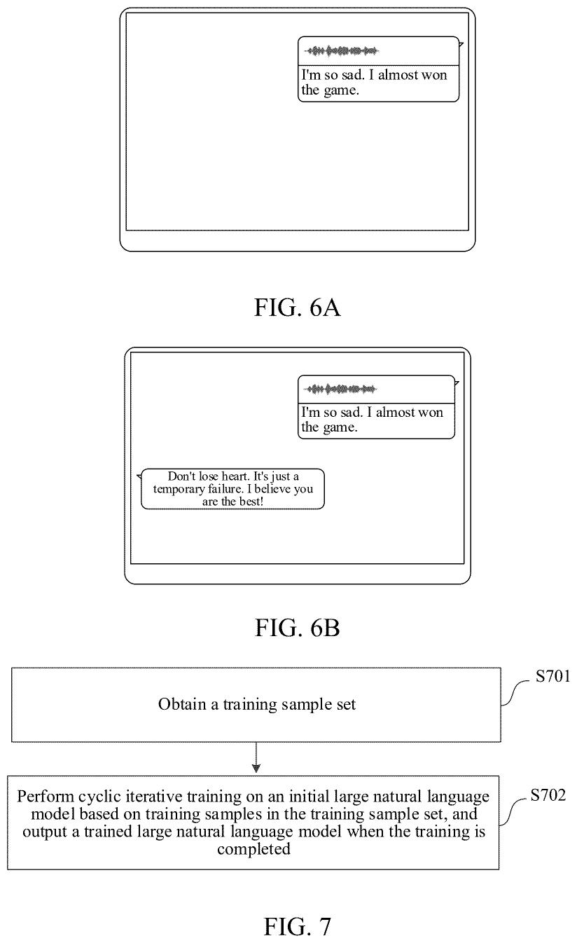

FIG. 6A is a schematic diagram of a presented interface according to an embodiment of this application. A display interface on a display screen of a soothing robot is used as an example. A target object is currently using the soothing robot. Multi-modal data inputted by the target object is: I'm so sad. I almost won the game. After receiving the multi-modal data, the soothing robot transmits the multi-modal data to a cloud server, and the cloud server determines, through a trained large natural language model, that a multi-modal data category corresponding to the multi-modal data is a negative sentiment, and a confidence score corresponding to the negative sentiment is 80%.

The cloud server determines a reply of “Don't lose heart. It's just a temporary failure. I believe you are the best” to the target object based on the negative sentiment and the confidence score of 80% corresponding to the negative sentiment through the trained large natural language model, and transmits the reply content to the soothing robot.

Alternatively, the cloud server inputs the multi-modal data category and the confidence score into a downstream task of the soothing robot, and determines, in the downstream task based on the multi-modal data category and the confidence score, that the reply content is “Don't lose heart. It's just a temporary failure. I believe you are the best”.

As shown in FIG. 6B, the soothing robot uses “Don't lose heart. It's just a temporary failure. I believe you are the best” as feedback information, and presents the feedback information to the target object on a display interface, to obtain the display interface of the soothing robot shown in FIG. 6B.

The foregoing data processing method is performed by an electronic device through the trained large natural language model. The trained large natural language model is trained based on a large number of training samples. A training process of the large natural language model is described in detail below. As shown in FIG. 7, a large natural language model may be trained based on the following operations S701-S702 in this embodiment.

Operation S701: Obtain a training sample set, the training sample set including a plurality of training samples, each of the training samples including object history data, and a sample category and auxiliary training information being set corresponding to each training sample.

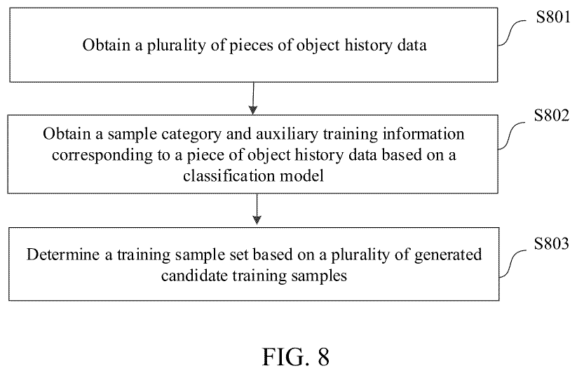

An embodiment of this application provides a flowchart of obtaining a training sample set shown in FIG. 8, specifically including the following operations S801-S803.

Operation S801: Obtain a plurality of pieces of object history data.

In some embodiments, the object history data may be obtained based on a corpus (for example: Wikipedia), or data inputted by any object available in a platform or a client. The object history data may be historical data inputted by any object, including an ID of an object and data inputted by the object.

The object history data may also be multi-modal data, which is not limited in this application.

A plurality of pieces of object history data are inputted into a classification model, and the following operation S802 and operation S803 are performed for each of the plurality of pieces of object history data.

Operation S802: Obtain a sample category and auxiliary training information corresponding to the object history data based on the classification model, and generate a candidate training sample based on the object history data and the sample category and the auxiliary training information corresponding to the object history data.

In the embodiments of this application, the classification model may be an open-source classification model, for example, a text data classification model. The sample category and the auxiliary training information corresponding to the object history data can be obtained based on the text data classification model.

The auxiliary training information is configured for characterizing a degree of accuracy of the sample category corresponding to the object history data.

A type of the sample category corresponding to the object history data is not limited in the embodiments of this application. In addition to the foregoing exemplary category of sentiment, for the type of the sample category, reference may be made to the type in the above multi-modal data category, and the type of the sample category may be the same as or different from the type in the multi-modal data category.

Operation S803: Determine a training sample set based on a plurality of generated candidate training samples.

In one embodiment, all or part of the plurality of generated candidate training samples are combined into a training sample set.

An implementation of determining the training sample set is: clustering the plurality of candidate training samples based on at least one of clustering conditions corresponding to the candidate training samples, to obtain a plurality of candidate training sample sets; and selecting at least one candidate training sample from each of the plurality of candidate training sample sets, to form a training sample set.

The clustering conditions include a sample category corresponding to the candidate training sample and auxiliary training information corresponding to the candidate training sample; and

In the embodiments of this application, the plurality of generated candidate training samples are clustered through at least one of the following Methods 1-3 based on the clustering conditions, to obtain a plurality of candidate training sample sets.

Method 1: cluster candidate training samples through a k-means clustering algorithm based on auxiliary training information corresponding to each candidate training sample.

In one embodiment, if one of the plurality of generated candidate training samples corresponds to only one sample category, the candidate training samples are clustered through the k-means clustering algorithm based on the auxiliary training information corresponding to the sample category.

In another embodiment, if one of the plurality of generated candidate training samples corresponds to a plurality of sample categories, the candidate training samples may be clustered through the k-means clustering algorithm based on the maximum value in auxiliary training information corresponding to the sample categories.

In some embodiments, if the sample category is a category of sentiment, one of the plurality of generated candidate training samples corresponds to a positive sentiment and a negative sentiment. Auxiliary training information of the positive sentiment is 70%, and auxiliary training information of the negative sentiment is 30%. Since the maximum value in the auxiliary training information corresponding to the positive sentiment and the negative sentiment is 70%, the candidate training samples are clustered through the k-means clustering algorithm based on 70%.

Method 2: Cluster, based on the auxiliary training information corresponding to each candidate training sample, the candidate training samples corresponding to the auxiliary training information that meet a preset range.

In one embodiment, if one of the plurality of generated candidate training samples corresponds to one sample category, the candidate training samples corresponding to the auxiliary training information that meet the preset range are clustered based on the auxiliary training information corresponding to the sample category.

In some embodiments, the candidate training samples corresponding to the auxiliary training information not greater than 60% are clustered based on the preset range, or the candidate training samples corresponding to the auxiliary training information greater than 60% are clustered based on the preset range.

A quantity of preset ranges is not limited in this application.

In another embodiment, if one of the plurality of generated candidate training samples corresponds to a plurality of sample categories, the candidate training samples may be clustered based on the maximum value in auxiliary training information corresponding to the sample categories and the preset range.

Method 3: Cluster the candidate training samples having the same sample category based on the sample category corresponding to each candidate training sample.

In some embodiments, if the sample category is a work field category, a sample category of a candidate training sample 1 is a service industry field, a sample category of a candidate training sample 2 is a lawyer field and a service industry field, and a sample category of a candidate training sample 3 is a scientific research field, the candidate training sample 1 and the candidate training sample 2 are clustered.

In one embodiment, if one of the plurality of generated candidate training samples corresponds to a plurality of sample categories, the sample category corresponding to the maximum value in the auxiliary training information corresponding to the candidate training samples may be used as the sample category of the candidate training sample, and the candidate training samples are clustered. Alternatively, the sample category corresponding to the auxiliary training information greater than a preset threshold in the auxiliary training information corresponding to the plurality of sample categories may be used as the sample category of the candidate training sample, and the candidate training sample is clustered.

Based on the plurality of candidate training sample sets obtained after the foregoing candidate training samples are clustered, at least one candidate training sample is selected from each of the plurality of candidate training sample sets, to form a training sample set.

Through the foregoing process, each candidate training sample in the candidate training sample set may have a common feature. At least one candidate training sample is selected from each candidate training sample set to form the training sample set, so that it may be ensured that the candidate training samples in the training sample set have many types of features, and the features in the training sample set are more abundant.

For ease of description, the candidate training sample in the training sample set is referred to as a training sample below.

During implementation, the training sample set includes a plurality of training samples, each of the training samples including object history data, and a sample category and auxiliary training information being set corresponding to each training sample.

The auxiliary training information is configured for characterizing the degree of accuracy of the sample category corresponding to the training sample.

In addition to training samples, the training sample set may further include a test sample.

The test sample is configured for detecting the accuracy of model training.

In some embodiments, any training sample in the training sample set may correspond to at least one sample category, and each sample category corresponds to a piece of auxiliary training information.

In some embodiments, for example, if a training sample is “Spring is coming”, a sample category corresponding to the training sample may be a positive sentiment and a negative sentiment, auxiliary training information corresponding to the positive sentiment may be 70%, and auxiliary training information corresponding to the negative sentiment may be 30%.

Based on the foregoing examples, in the training sample sets in the embodiments of this application, for any training sample, if the sample category corresponding to the training sample is a category of sentiment, forms of the object history data included in the training sample, and the sample category and the auxiliary training information corresponding to the training sample in the training sample set may be: xᵢ→positive=cᵢ[0], negative=cᵢ[1].

xᵢxᵢ represents object history data included in any training sample in the training sample set, positive and negative respectively represent a positive sentiment and a negative sentiment in the category of sentiment corresponding to the training sample, cᵢ[0] represents the auxiliary training information corresponding to the positive sentiment, and cᵢ[1] represents the auxiliary training information corresponding to the negative sentiment.

In some embodiments, the form of the training sample whose sample category is the category of sentiment in the training sample set may be represented as:

### Sentiment Analysis

Great piece of→positive=100%, negative=0%
the quirky→positive=90%, negative=10%
fails on its own→positive=100%, negative=0%
its entertaining→positive=90%, negative=0%

Sentiment Analysis represents a category of sentiment, Great piece of, the quirky, fails on its own, and its entertaining represent object history data included in each exemplary training sample, positive and negative respectively represent the positive sentiment and the negative sentiment in the category of sentiment, and percentages corresponding to the positive sentiment and the negative sentiment represent corresponding auxiliary training information.

In some embodiments, for Great piece of→positive=100%, negative=0%, 100% represents that auxiliary training information of the positive sentiment corresponding to Great piece of is 100%, and 0% represents that the auxiliary training information of the negative sentiment corresponding to Great piece of is 0%.

A type of the sample category corresponding to the training sample is not limited in the embodiments of this application. In addition to the foregoing exemplary positive sentiment and negative sentiment, for the type of the sample category, reference may be made to the type in the above multi-modal data category, and the type of the sample category may be the same as or different from the type in the multi-modal data category.

The foregoing process of obtaining a training sample set is described through examples with reference to the accompanying drawings:

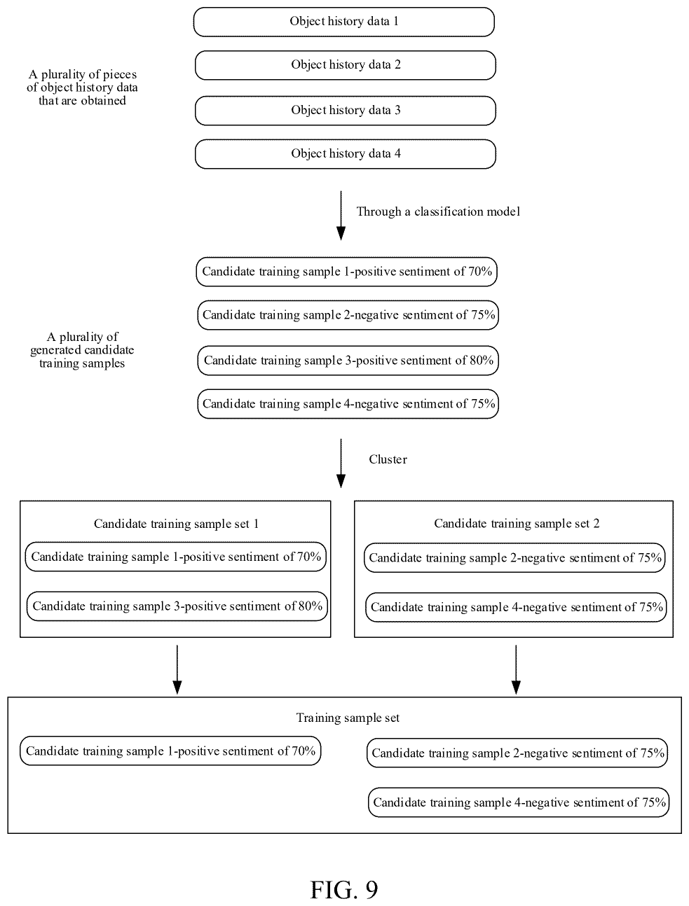

FIG. 9 is a schematic diagram of clustering according to an embodiment of this application. An example in which candidate training samples are clustered based on sample categories corresponding to the candidate training samples in a candidate training sample set is used. As shown in FIG. 9, a plurality of pieces of object history data are obtained, and a plurality of generated candidate training samples are determined through a classification model. A sample category corresponding to a candidate training sample 1 is a positive sentiment, and auxiliary training information corresponding to the positive sentiment is 70%; a sample category corresponding to a candidate training sample 2 is a negative sentiment, and auxiliary training information corresponding to the negative sentiment is 75%; a sample category corresponding to a candidate training sample 3 is the positive sentiment, and auxiliary training information corresponding to the positive sentiment is 80%; and a sample category corresponding to a candidate training sample 4 is the negative sentiment, and auxiliary training information corresponding to the negative sentiment is 75%. The candidate training sample 1 and the candidate training sample 3 are clustered as a candidate training sample set 1; and the candidate training sample 2 and the candidate training sample 4 are clustered as a candidate training sample set 2. The candidate training sample 1 is selected from the candidate training sample set 1, and the candidate training sample 2 and the candidate training sample 4 are selected from the candidate training sample set 2. The candidate training sample 1, the candidate training sample 2, and the candidate training sample 4 are combined into a training sample set.

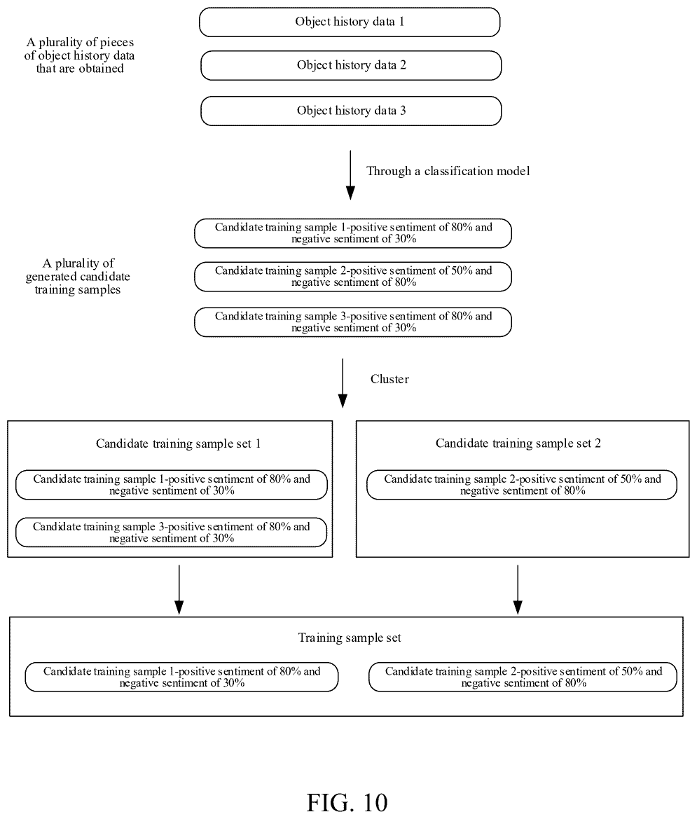

FIG. 10 is a schematic diagram of clustering according to an embodiment of this application. An example in which candidate training samples are clustered based on sample categories corresponding to the candidate training samples in a candidate training sample set is used. As shown in FIG. 10, a plurality of pieces of object history data are obtained, and a plurality of generated candidate training samples are determined through a classification model. Candidate training samples 1 correspond to a positive sentiment and a negative sentiment, auxiliary training information corresponding to the positive sentiment is 80%, and auxiliary training information corresponding to the negative sentiment is 30%; candidate training samples 2 correspond to a positive sentiment and a negative sentiment, auxiliary training information corresponding to the positive sentiment is 50%, and auxiliary training information corresponding to the negative sentiment is 80%; and candidate training samples 3 correspond to a positive sentiment and a negative sentiment, auxiliary training information corresponding to the positive sentiment is 80%, and auxiliary training information corresponding to the negative sentiment is 30%. For the candidate training sample 1, the auxiliary training information of 80% corresponding to the positive sentiment corresponding to the candidate training sample is the maximum value in the auxiliary training information. For the candidate training sample 3, the auxiliary training information of 80% corresponding to the positive sentiment corresponding to the candidate training sample is also the maximum value in the auxiliary training information. Therefore, the candidate training sample 1 and the candidate training sample 3 may be clustered based on the positive sentiment, to form a candidate training sample set 1. For the candidate training samples 2, the auxiliary training information of 80% corresponding to the negative sentiment corresponding to the candidate training samples is the maximum value in the auxiliary training information. Therefore, the candidate training samples 2 may be clustered based on the negative sentiment, to form a candidate training sample set 2. The candidate training sample 1 is selected from the candidate training sample set 1, and the candidate training sample 2 is selected from the candidate training sample set 2. The candidate training sample 1 and the candidate training sample 2 are combined into a training sample set.

Operation S702: Perform iterative training on an initial large natural language model based on a plurality of training samples in the training sample set, and output a trained large natural language model when the training is completed.

During the iterative training of the initial large natural language model, a iterative training process is explained as follows.

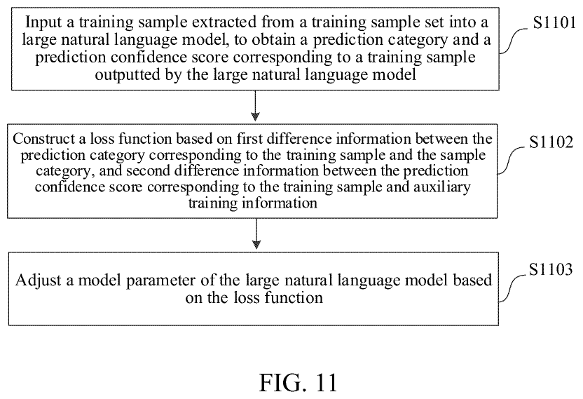

FIG. 11 is a flowchart of a iterative training process according to an embodiment of this application, specifically including operations S1101-S1103 as follows.

Operation S1101: Input each training sample extracted from a training sample set into a large natural language model, to obtain a prediction category and a prediction confidence score corresponding to a training sample outputted by the large natural language model.

In some embodiments, the extracted training samples may be spliced, and spliced training samples may be inputted into the large natural language model.

In some embodiments, if a sample category corresponding to the extracted training samples is a category of sentiment, the spliced training samples are: [test example]→positive=c[0], negative=c[1].

[test example] represents the spliced training samples, positive and negative respectively represent a positive sentiment and a negative sentiment in the categories of sentiment corresponding to the spliced training samples, c[0] represents auxiliary training information corresponding to the positive sentiment, and c[1] represents auxiliary training information corresponding to the negative sentiment.

In one embodiment, based on an input layer in the large natural language model, feature extraction is performed on each of the training samples, to obtain an element feature and a position feature corresponding to the training sample. Based on an embedding layer in the large natural language model, the element feature and the position feature corresponding to the training sample are fused to obtain a fused feature. Based on at least one encoding layer of the large natural language model, the prediction category corresponding to the training sample and a prediction confidence score corresponding to the prediction category are determined based on the fused feature and an initial weight matrix corresponding to each encoding layer in the large natural language model.

The initial weight matrix corresponding to each encoding layer may be composed of random numerical values, and the initial weight matrix corresponding to each encoding layer may be the same or different, which is not limited in this application.

For a type of the prediction category, reference may be made to the type in the above multi-modal data category, and may be the same as or different from the type in the multi-modal data category, which is not limited in this application.

Operation S1102: Construct a loss function based on first difference information between the prediction category corresponding to the training sample and the sample category, and second difference information between the prediction confidence score corresponding to the training sample and the auxiliary training information.

In this embodiment, for any training sample in the training sample set, the first difference information corresponding to the training sample is determined based on the prediction category obtained by the training sample through the large natural language model and the sample category corresponding to the training sample in the training sample set, and the second difference information corresponding to the training sample is determined based on the prediction confidence score obtained by the training sample through the large natural language model and the auxiliary training information corresponding to the training sample in the training sample set.

The loss function is constructed based on the first difference information corresponding to a plurality of training samples and the second difference information corresponding to the plurality of training samples.

In the embodiments of this application, for a training sample in the training sample set, if the training sample corresponds to a plurality of prediction categories, the prediction category whose category is the same as the sample category and the prediction category whose category is different from the sample category are determined in the prediction categories, and first difference information between these different prediction categories and the sample category is determined. If a plurality of pieces of first difference information are determined for the training sample, an average operation may be performed on the plurality of pieces of first difference information, and a result of the average operation is determined as the first difference information corresponding to the training sample.

In a case that the training sample corresponds to a plurality of prediction categories, because each prediction category corresponds to a prediction confidence score, a plurality of pieces of second difference information corresponding to the training sample are obtained. An average operation may be performed on the plurality of pieces of second difference information, and a result of the average operation is determined as the second difference information corresponding to the training sample.

In one embodiment, the loss function may also be directly constructed based on the plurality of pieces of first difference information and the plurality of pieces of second difference information corresponding to the training sample.

During the training of the large natural language model, it is expected that a difference between a training sample and a prediction sample is as small as possible. Therefore, the loss function needs to be used to measure whether the prediction of the large natural language model is accurate. Generally, a method such as the least squares method, maximum likelihood estimation, or a cross entropy may be used to construct a loss function.

In some embodiments, the least squares method is used as an example. The first difference information may further be a square of a difference between each prediction category and the sample category corresponding to a training sample, and the second difference information may be a square of a difference between a confidence score corresponding to a prediction category and the confidence score of the sample category corresponding to the training sample. The loss function constructed based on the first difference information and the second difference information may be a sum of the first difference information and the second difference information. When the loss function, i.e., the sum of the first difference information and the second difference information, is the minimum, it is considered that the training of the large natural language model is completed. A method for determining quantities of first difference information and second difference information corresponding to a training sample is not limited in this application.

Operation S1103: Adjust a model parameter of the large natural language model based on the loss function.

A plurality of rounds of cyclic training are performed on the large natural language model based on the foregoing process of training the large natural language model. When a model parameter of the large natural language model meets a preset condition, the training of the large natural language model is completed. The preset condition may be that a loss calculated through the loss function is the minimum.

Through adjustment of the parameter of the large natural language model above, a trained large natural language model can be obtained.

The embodiments of this application provide an overall process of training the large natural language model. Specific operations include the following B1-B7.

B1: Obtain a plurality of pieces of object history data.

B2: Input the plurality of pieces of object history data into a classification model, to generate a plurality of corresponding candidate training samples.

B3: Cluster the candidate training samples through a k-means clustering algorithm based on auxiliary training information corresponding to each candidate training sample, to obtain a plurality of candidate training sample sets.

k is a predefined number, for example, 8.

Each candidate training sample set is equivalent to a cluster.

The process of clustering the candidate training samples through the k-means clustering algorithm has been explained in the embodiment of operation S803, and details are not described herein again.

B4: Select at least one candidate training sample from each of the plurality of candidate training sample sets, to form a training sample set.

After a candidate training sample is selected from the plurality of candidate training sample sets, the candidate training sample is represented in the following form: xᵢ→positive=cᵢ[0], negative=cᵢ[1], and the selected candidate training sample is combined into a training sample set.

xᵢ represents a candidate training sample selected from the candidate training sample set, positive and negative respectively represent a positive sentiment and a negative sentiment in a category of sentiment corresponding to the candidate training sample, cᵢ[0] represents auxiliary training information corresponding to the positive sentiment, and cᵢ[1] represents auxiliary training information corresponding to the negative sentiment.

Therefore, the training sample set includes a candidate training sample, and a sample category and auxiliary training information corresponding to the candidate training sample. For ease of understanding, the candidate training sample in the training sample set, and the sample category and auxiliary training information corresponding to the candidate training sample are respectively referred to as a training sample, and a sample category and auxiliary training information corresponding to the training sample below.

B5: Input a training sample in the training sample set into an initial large natural language model, and output a prediction category corresponding to the training sample and a prediction confidence score corresponding to the prediction category through an initial large natural language model.

In one embodiment, before the training samples in the training sample set is inputted into the initial large natural language model, the training samples may be spliced.

In some embodiments, if a category of sentiment corresponding to the extracted training samples is a category of sentiment, the spliced training samples are:

[test example] represents the spliced training samples, positive and negative respectively represent a positive sentiment and a negative sentiment in the categories of sentiment corresponding to the spliced training samples, c[0] represents auxiliary training information corresponding to the positive sentiment, and c[1] represents auxiliary training information corresponding to the negative sentiment.

B6: Determine the maximum value in the outputted prediction confidence score, use a prediction category corresponding to the maximum value of the prediction confidence score as a final prediction category of the training sample, and use the prediction confidence score as a final prediction confidence score of the training sample.

B7: Adjust a model parameter of the large natural language model based on the final prediction category of the training sample and the final prediction confidence score of the training sample, to obtain a trained large natural language model.

A loss function is constructed based on first difference information between the final prediction category of the training sample and the sample category corresponding to the training sample, and second difference information between the final prediction confidence score of the training sample and the auxiliary training information corresponding to the training sample. The model parameter of the large natural language model is adjusted based on the loss function, to obtain a trained large natural language model.

Several specific application scenarios in the data processing method are described through examples below.

In one embodiment, the data processing method may be applied to the following several scenarios:

### Scenario I: Chatbots

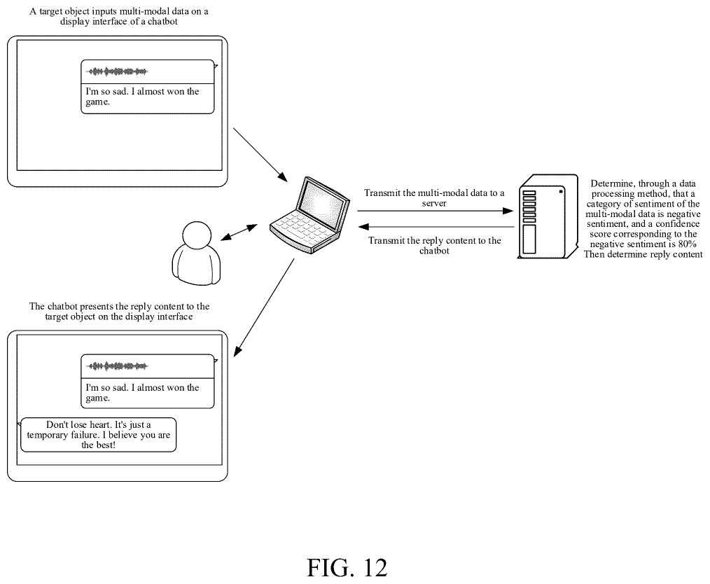

FIG. 12 is a schematic logic diagram of application to a chatbot according to an embodiment of this application. As shown in FIG. 12, a target object inputs “I'm so sad. I almost won the game” in a display interface of the chatbot, and the chatbot transmits obtained multi-modal data to a cloud server. The cloud server determines, through the data processing method, a category of sentiment of the multi-modal data is a negative sentiment, and a confidence score corresponding to the negative sentiment is 80%. The cloud server determines, based on the negative sentiment and the confidence score of 80% corresponding to the negative sentiment, that reply content is “Don't lose heart. It's just a temporary failure. I believe you are the best”, and transmits the reply content to the chatbot. The chatbot presents the reply content to the target object on the display interface.

### Scenario II: Resume Evaluation Systems

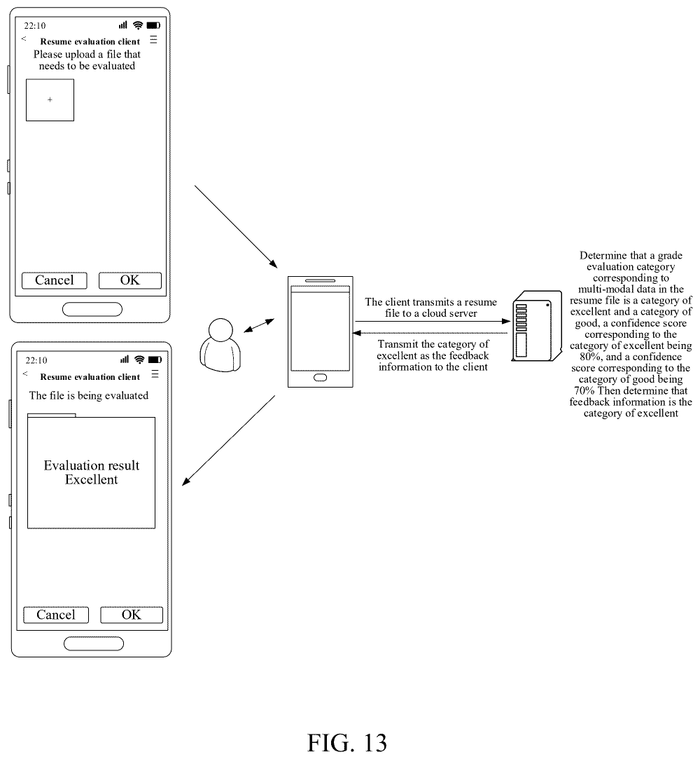

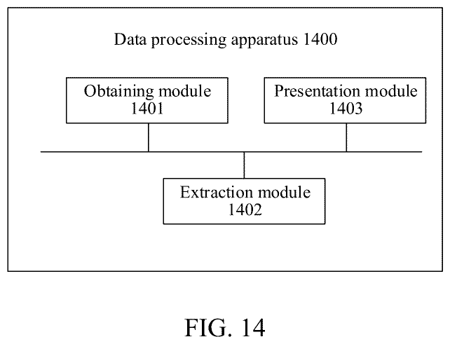

FIG. 13 is a schematic logic diagram of application to a resume evaluation system according to an embodiment of this application. As shown in FIG. 13, a resume file is uploaded to a client through a resume evaluation client. The client transmits the resume file with multi-modal data inputted by a target object to a cloud server, and the cloud server determines, based on a trained large natural language model deployed in the cloud server through a data processing method, that a grade evaluation category corresponding to the multi-modal data in the resume file is a category of excellent and a category of good. A confidence score corresponding to the category of excellent is 80%, indicating that accuracy of the resume file belonging to the category of excellent is 80%. A confidence score corresponding to the category of good is 70%, indicating that accuracy of the resume file belonging to the category of excellent is 70%. The cloud server determines, based on the confidence score corresponding to the category of excellent being 80% and the confidence score corresponding to the category of good being 70%, that the confidence score corresponding to the category of excellent is higher than the confidence score corresponding to the category of good, transmits the category of excellent as feedback information to the corresponding client, and presents a result of “category of excellent” to the target object in the client.

For ease of description, the foregoing parts are divided into modules based on functions and described respectively. In embodiments of this application, the functions of the modules may be implemented in the same piece of or a plurality of pieces of software or hardware.

A person skilled in the art can understand that the aspects of this application may be implemented as systems, methods, or program products. Therefore, the aspects of this application may be specifically embodied in the following forms: a hardware only implementation, a software only implementation (including firmware, microcode, and the like), or an implementation of a combination of software and hardware, which may be collectively referred to as a “circuit”, a “module”, or a “system” herein.

Regarding the apparatus in the above embodiments, a specific execution manner of each module has been described in detail in the embodiments related to the method, and the details are not described herein.

Based on the same inventive concept, an embodiment of this application provides a data processing apparatus. The principle for the apparatus to resolve a problem is the same as the method in the foregoing embodiments. Therefore, for implementation of the apparatus, reference may be made to the implementation of the foregoing method. Repeated parts are not described again.

A data processing apparatus 1400 provided in this embodiment includes an obtaining module 1401, an extraction module 1402, and a presentation module 1403.

The obtaining module 1401 is configured to obtain multi-modal data inputted by a target object, and input the multi-modal data into a large natural language model.

The extraction module 1402 is configured to perform the following operations based on the trained large natural language model: performing feature extraction on the multi-modal data to obtain an element feature and a position feature of the multi-modal data, the element feature being configured for characterizing element information of each element in the multi-modal data, and the position feature being configured for characterizing a character position of each element in the multi-modal data; fusing the element feature and the position feature corresponding to the multi-modal data to obtain a fused feature; obtaining a multi-modal data category of the multi-modal data and a confidence score corresponding to the multi-modal data category based on the fused feature, the confidence score being configured for characterizing a degree of accuracy of a corresponding classification result, and the large natural language model being trained by inputting auxiliary training information during training of the large natural language model, so that the large natural language model obtains the confidence score corresponding to the multi-modal data after the training is completed, the auxiliary training information being configured for characterizing a degree of accuracy of a sample category corresponding to a training sample for training the large natural language model; and

The presentation module 1403 is configured to present corresponding feedback information to the target object based on the multi-modal data category and the confidence score.

In the embodiments of this application, during the training of the large natural language model, the auxiliary training information is inputted to train the large natural language model, so that the trained large natural language model can output the multi-modal data category and the confidence score corresponding to the multi-modal data. Therefore, reliability of making a decision by the target object based on the outputted results can be improved based on the outputted multi-modal data category and confidence score corresponding to the multi-modal data.

In one embodiment, the extraction module 1401 is further configured to receive the multi-modal data inputted by the target object, and divide the multi-modal data into each element; obtain a corresponding element feature based on element information of each element, and obtain an element feature of the multi-modal data based each element feature; and obtain a corresponding position feature based on a character position of each element in the multi-modal data.

In one embodiment, the extraction module 1401 is further configured to perform the following operation in at least one encoding layer of the large natural language model:
determining the multi-modal data category corresponding to the multi-modal data and the confidence score corresponding to the multi-modal data category based on the fused feature and a weight matrix corresponding to each encoding layer,
the weight matrix corresponding to each encoding layer being determined during the training of the trained large natural language model.

In one embodiment, the large natural language model is trained in the following manners:
obtaining a training sample set, the training sample set including a plurality of training samples, each of the training samples including object history data, and a sample category and auxiliary training information being set corresponding to each training sample; and
performing iterative training on an initial large natural language model based on the plurality of training samples in the training sample set, and outputting the trained large natural language model when the training is completed.

In one embodiment, the extraction module 1401 is further configured to perform the following operations in a iterative training process:
inputting each training sample extracted from the training sample set into the large natural language model, to obtain a prediction category and a prediction confidence score corresponding to the training sample outputted by the large natural language model;
constructing a loss function based on first difference information between the prediction category corresponding to the training sample and the sample category, and second difference information between the prediction confidence score corresponding to the training sample and the auxiliary training information; and
adjusting a model parameter of the large natural language model based on the loss function.

In one embodiment, the extraction module 1401 is further configured to:
obtain a plurality of pieces of object history data;
input the plurality of pieces of object history data into a classification model, and perform the following operations for each of the plurality of pieces of object history data:
obtain a sample category and auxiliary training information corresponding to the object history data based on the classification model; generate a candidate training sample based on the object history data, the sample category and the auxiliary training information corresponding to the object history data; and
determine the training sample set based on a plurality of generated candidate training samples.

In one embodiment, the extraction module 1401 is further configured to:
cluster the plurality of candidate training samples based on at least one of clustering conditions corresponding to the candidate training samples, to obtain a plurality of candidate training sample sets, the clustering conditions including: a sample category corresponding to the candidate training sample and auxiliary training information corresponding to the candidate training sample; and
select at least one candidate training sample from each of the plurality of candidate training sample sets, to form the training sample set.

In one embodiment, the multi-modal data inputted by the target object includes at least one of the following: multi-modal data including a modal element, multi-modal data including an emotional element, and multi-modal data including an adjective element.

The multi-modal data category includes a category of sentiment.

In one embodiment, the presentation module 1403 is further configured to:
use the corresponding multi-modal data category as feedback information based on the confidence score, and present the feedback information to the target object; or
determine reply content based on the multi-modal data category and the confidence score, use the reply content as feedback information, and present the feedback information to the target object.

In some embodiments, an electronic device in the embodiments of this application may include at least one processor and at least one memory. The memory has program code stored therein, the program code, when executed by the processor, causing the processor to perform the operations in the data processing method according to various exemplary implementations of this application described above.

Based on the same inventive concept as the foregoing method embodiments, an embodiment of this application further provides an electronic device. The principle for the electronic device to resolve a problem is the same as the method in the foregoing embodiments. Therefore, for embodiments of the electronic device, reference may be made to the implementation of the foregoing method. Repeated parts are not described again.

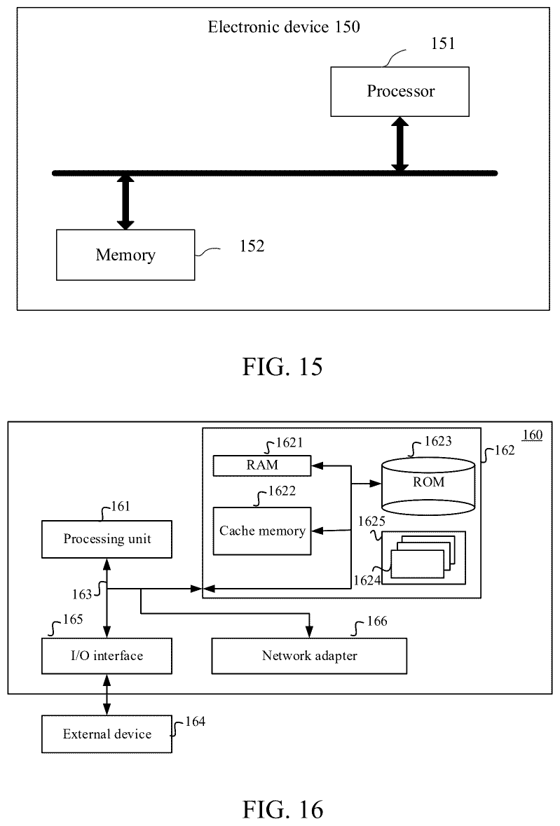

As shown in FIG. 15, an electronic device 150 may include at least a processor 151 and a memory 152. The memory 152 has program code stored therein, the program code, when executed by the processor 151, causing the processor 151 to perform the operations of any data processing method in any one of the foregoing embodiments of this application.

An electronic device 160 according to an embodiment of this application is described below with reference to FIG. 16. An electronic device 160 in FIG. 16 is merely an example, and is not to constitute any limitation on functions and usage scope of the embodiments of this application.

As shown in FIG. 16, the electronic device 160 is represented in a form of a general electronic device. Components of the electronic device 160 may include, but are not limited to at least one processing unit 161, at least one storage unit 162, and a bus 163 connecting different system components (including a storage unit 162 and a processing unit 161).

The bus 163 may be one or more of a plurality of types of bus structures, including a memory bus or a memory controller, a peripheral bus, a processor, or a local bus that uses any one of the plurality of types of bus structures.

The storage unit 162 may include a readable medium in a form of a volatile memory or a non-volatile memory, such as a random access memory (RAM) 1621 and/or a cache storage unit 1622, and may further include a read-only memory (ROM) 1623.

The storage unit 162 may further include a program/utility tool 1625 having a set of (at least one) program modules 1624. Such program modules 1624 include but are not limited to an operating system, one or more applications, another program module, and program data. Each or a combination of these examples may include implementation of a network environment.

The electronic device 160 may also communicate with one or more external devices 164 (such as a keyboard and a pointing device), and may further communicate with one or more devices that enable an object to interact with the electronic device 160, and/or any device (such as a router or a modem) that enables the electronic device 160 to communicate with one or more other electronic devices. Such communication may be performed through an input/output (I/O) interface 165. In addition, the electronic device 160 may further communicate with one or more networks (such as a local area network (LAN), a wide area network (WAN) and/or a public network such as the Internet) through a network adapter 166. As shown in the figure, the network adapter 166 is configured to communicate with another module of the electronic device 160 through the bus 163. Although not shown in the figure, the electronic device 160 may use another hardware and/or software module, including but not limited to: microcode, a device driver, a redundant processor, an external disk drive array, a RAID system, a tape driver, a data backup storage system, and the like.

Based on the same inventive concept as the foregoing method embodiments, each aspect of the data processing method provided in this application may be further implemented in a form of a program product, which includes a program code. When the program product is run on an electronic device, the program code is configured for causing the electronic device to perform the operations in the data processing method based on various embodiments of this application described above.

The program product may be any combination of one or more readable media. The readable medium may be a readable signal medium or a readable storage medium. The readable storage medium may be, for example, but is not limited to, an electric, magnetic, optical, electromagnetic, infrared, or semi-conductive system, apparatus, or device, or any combination thereof. More specific examples (a non-exhaustive list) of the readable storage medium include: an electrical connection by one or more wires, a portable computer disk, a hard disk, a RAM, a ROM, an erasable programmable ROM (EPROM or a flash memory), an optical fiber, a portable compact disk ROM (CD-ROM), an optical memory device, a magnetic storage device, or any appropriate combination thereof.

Although the embodiments of this application have been described, additional changes and modifications to these embodiments may be made by a person skilled in the art once the basic creative concept is apparent. Therefore, the appended claims are intended to be interpreted as including the embodiments and all changes and modifications that fall within the scope of this application.

Apparently, a person skilled in the art may make various modifications and variations to this application without departing from the spirit and scope of this application. In this way, if the modifications and variations made to this application fall within the scope of the claims of this application and their equivalent technologies, this application is also intended to include these modifications and variations.

What is claimed is:

1. A data processing method, performed by an electronic device, the method comprising:
receiving multi-modal data, and inputting the multi-modal data into a large natural language model;
performing the following operations based on the large natural language model:
performing feature extraction on the multi-modal data to obtain an element feature and a position feature of the multi-modal data, the element feature characterizing element information of each element in the multi-modal data, and the position feature characterizing a character position of each element in the multi-modal data;
fusing the element feature and the position feature corresponding to the multi-modal data to obtain a fused feature;
obtaining a multi-modal data category of the multi-modal data and a confidence score corresponding to the multi-modal data category based on the fused feature, the confidence score characterizing a degree of accuracy of a corresponding classification result, and the large natural language model being trained by inputting auxiliary training information during training of the large natural language model, so that the large natural language model is configured to obtain the confidence score corresponding to the multi-modal data after the training is completed, the auxiliary training information characterizing a degree of accuracy of a sample category corresponding to a training sample for training the large natural language model; and
presenting corresponding feedback information based on the multi-modal data category and the confidence score.

2. The method according to claim 1, wherein the performing feature extraction on the multi-modal data to obtain an element feature and a position feature of the multi-modal data comprises:
dividing the multi-modal data into each element;
obtaining an element feature of each element based on element information of each element, to obtain an element feature of the multi-modal data; and
obtaining a corresponding position feature based on a character position of each element in the multi-modal data.

3. The method according to claim 2, wherein the large natural language model comprises an input layer, an embedding layer, and at least one encoding layer; and
the obtaining a multi-modal data category of the multi-modal data and a confidence score corresponding to the multi-modal data category based on the fused feature comprises:
performing the following operation in at least one encoding layer of the large natural language model:
determining the multi-modal data category corresponding to the multi-modal data and the confidence score corresponding to the multi-modal data category based on the fused feature and a weight matrix corresponding to each encoding layer,
the weight matrix corresponding to each encoding layer being determined during the training of the large natural language model.

4. The method according to claim 1, wherein training the large natural language model comprising:
obtaining a training sample set, the training sample set comprising a plurality of training samples, each of the training samples comprising object history data, and a sample category and auxiliary training information being set corresponding to each training sample; and
performing iterative training on an initial large natural language model based on the plurality of training samples in the training sample set, and outputting the trained large natural language model when the training is completed.

5. The method according to claim 4, wherein the performing iterative training on an initial large natural language model based on the plurality of training samples in the training sample set specifically comprises:
performing the following operations in an iterative training process:
inputting each training sample extracted from the training sample set into the large natural language model, to obtain a prediction category and a prediction confidence score corresponding to the training sample outputted by the large natural language model;
constructing a loss function based on first difference information between the prediction category corresponding to the training sample and the sample category, and second difference information between the prediction confidence score corresponding to the training sample and the auxiliary training information; and
adjusting a model parameter of the large natural language model based on the loss function.

6. The method according to claim 4, wherein the obtaining a training sample set comprises:
obtaining a plurality of pieces of object history data;
inputting the plurality of pieces of object history data into a classification model, and performing the following operations for each of the plurality of pieces of object history data:
obtaining a sample category and auxiliary training information corresponding to the object history data based on the classification model; generating a candidate training sample based on the object history data, the sample category and the auxiliary training information corresponding to the object history data; and
determining the training sample set based on a plurality of generated candidate training samples.

7. The method according to claim 6, wherein the determining the training sample set based on a plurality of generated candidate training samples comprises:
clustering the plurality of candidate training samples based on at least one of clustering conditions corresponding to the candidate training samples, to obtain a plurality of candidate training sample sets, the clustering conditions comprising: a sample category corresponding to the candidate training sample and auxiliary training information corresponding to the candidate training sample; and
selecting at least one candidate training sample from each of the plurality of candidate training sample sets, to form the training sample set.

8. The method according to claim 1, wherein the multi-modal data comprises at least one of the following: multi-modal data comprising a modal element, multi-modal data comprising an emotional element, and multi-modal data comprising an adjective element; and
the multi-modal data category comprises a category of sentiment.

9. The method according to claim 1, wherein the presenting corresponding feedback information based on the multi-modal data category and the confidence score comprises:
using the corresponding multi-modal data category as feedback information based on the confidence score, and presenting the feedback information; or determining reply content based on the multi-modal data category and the confidence score, using the reply content as feedback information, and presenting the feedback information.

10. A data processing apparatus, comprising:
comprising a processor and a memory, the memory having a program code stored therein, the processor being, when executing the program code, configured to:
obtain multi-modal data, and input the multi-modal data into a large natural language model;
perform the following operations based on the large natural language model: performing feature extraction on the multi-modal data to obtain an element feature and a position feature of the multi-modal data, the element feature characterizing element information of each element in the multi-modal data, and the position feature characterizing a character position of each element in the multi-modal data;
fuse the element feature and the position feature corresponding to the multi-modal data to obtain a fused feature;
obtain a multi-modal data category corresponding to the multi-modal data and a confidence score corresponding to the multi-modal data category based on the fused feature, the confidence score characterizing a degree of accuracy of a corresponding classification result, and the large natural language model being trained by inputting auxiliary training information during training of the large natural language model, so that the large natural language model obtains the confidence score corresponding to the multi-modal data after the training is completed, the auxiliary training information characterizing a degree of accuracy of a sample category corresponding to a training sample for training the large natural language model; and
present corresponding feedback information based on the multi-modal data category and the confidence score.

11. The apparatus according to claim 10, wherein the processor is further configured to:
receive the multi-modal data, and divide the multi-modal data into each element;
obtain an element feature of each element based on element information of each element, to obtain an element feature of the multi-modal data; and
obtain a corresponding position feature based on a character position of each element in the multi-modal data.

12. The apparatus according to claim 11, wherein the large natural language model comprises an input layer, an embedding layer, and at least one encoding layer; and
the processor is further configured to perform the following operation in at least one encoding layer of the large natural language model:
determining the multi-modal data category corresponding to the multi-modal data and the confidence score corresponding to the multi-modal data category based on the fused feature and a weight matrix corresponding to each encoding layer,
the weight matrix corresponding to each encoding layer being determined during the training of the large natural language model.

13. The apparatus according to claim 10, wherein the large natural language model is trained in the following manners:
obtaining a training sample set, the training sample set comprising a plurality of training samples, each of the training samples comprising object history data, and a sample category and auxiliary training information being set corresponding to each training sample; and
performing iterative training on an initial large natural language model based on the plurality of training samples in the training sample set, and outputting the trained large natural language model when the training is completed.

14. The apparatus according to claim 13, wherein the performing iterative training on an initial large natural language model based on the plurality of training samples in the training sample set specifically comprises:
performing the following operations in a iterative training process:
inputting each training sample extracted from the training sample set into the large natural language model, to obtain a prediction category and a prediction confidence score corresponding to the training sample outputted by the large natural language model;
constructing a loss function based on first difference information between the prediction category corresponding to the training sample and the sample category, and second difference information between the prediction confidence score corresponding to the training sample and the auxiliary training information; and
adjusting a model parameter of the large natural language model based on the loss function.

15. The apparatus according to claim 13, wherein the processor is further configured to:
obtain a plurality of pieces of object history data;
input the plurality of pieces of object history data into a classification model, and perform the following operations for each of the plurality of pieces of object history data:
obtain a sample category and auxiliary training information corresponding to the object history data based on the classification model; generate a candidate training sample based on the object history data, the sample category and the auxiliary training information corresponding to the object history data; and
determine the training sample set based on a plurality of generated candidate training samples.

16. The apparatus according to claim 15, wherein the processor is further configured to:
cluster the plurality of candidate training samples based on at least one of clustering conditions corresponding to the candidate training samples, to obtain a plurality of candidate training sample sets, the clustering conditions comprising: a sample category corresponding to the candidate training sample and auxiliary training information corresponding to the candidate training sample; and
select at least one candidate training sample from each of the plurality of candidate training sample sets, to form the training sample set.

17. The apparatus according to claim 10, wherein the multi-modal data comprises at least one of the following: multi-modal data comprising a modal element, multi-modal data comprising an emotional element, and multi-modal data comprising an adjective element; and
the multi-modal data category comprises a category of sentiment.

18. A non-transitory computer-readable storage medium, comprising a computer program, the computer program, when run on an electronic device, causing the electronic device to perform:
receiving multi-modal data, and inputting the multi-modal data into a large natural language model;
performing the following operations based on the large natural language model:
performing feature extraction on the multi-modal data to obtain an element feature and a position feature of the multi-modal data, the element feature characterizing element information of each element in the multi-modal data, and the position feature characterizing a character position of each element in the multi-modal data;
fusing the element feature and the position feature corresponding to the multi-modal data to obtain a fused feature;
obtaining a multi-modal data category of the multi-modal data and a confidence score corresponding to the multi-modal data category based on the fused feature, the confidence score characterizing a degree of accuracy of a corresponding classification result, and the large natural language model being trained by inputting auxiliary training information during training of the large natural language model, so that the large natural language model is configured to obtain the confidence score corresponding to the multi-modal data after the training is completed, the auxiliary training information characterizing a degree of accuracy of a sample category corresponding to a training sample for training the large natural language model; and
presenting corresponding feedback information based on the multi-modal data category and the confidence score.

19. The storage medium according to claim 18, wherein the performing feature extraction on the multi-modal data to obtain an element feature and a position feature of the multi-modal data comprises:
dividing the multi-modal data into each element;
obtaining an element feature of each element based on element information of each element, to obtain an element feature of the multi-modal data; and
obtaining a corresponding position feature based on a character position of each element in the multi-modal data.

20. The storage medium according to claim 19, wherein the large natural language model comprises an input layer, an embedding layer, and at least one encoding layer; and
the obtaining a multi-modal data category of the multi-modal data and a confidence score corresponding to the multi-modal data category based on the fused feature comprises:
performing the following operation in at least one encoding layer of the large natural language model:
determining the multi-modal data category corresponding to the multi-modal data and the confidence score corresponding to the multi-modal data category based on the fused feature and a weight matrix corresponding to each encoding layer,
the weight matrix corresponding to each encoding layer being determined during the training of the large natural language model.
